(19) United States
(12) Patent Application Publication
(10) Pub. No.: US 2024/0109177 A1
(43) Pub. Date: Apr. 4, 2024

(54) SMALL INTELLIGENT ROBOT SYSTEM

(71) Applicants: Tianqi (George) Sun, Wallingford, CT (US); Zheng (James) Zhou, Great Neck, NY (US)

(72) Inventors: Tianqi (George) Sun, Wallingford, CT (US); Zheng (James) Zhou, Great Neck, NY (US)

(21) Appl. No.: 17/958,324

(22) Filed: Oct. 1, 2022

(51) Int. Cl. B25J 9/00; B25J 5/00; B25J 9/16; B25J 11/00; B25J 13/08; B25J 19/00; B25J 19/02

(52) U.S. Cl. CPC B25J 9/0003; B25J 5/007; B25J 9/1666; B25J 9/1697; B25J 11/0005; B25J 13/088; B25J 19/0025; B25J 19/023

(57) ABSTRACT

A small intelligent robot system includes a main body including a right driving wheel and a left driving wheel at both sides thereof; a camera module that takes photos located above the main body; a speech recognition module that receives input indicative of a user request; and an internet connection processor that initiates a telephone call in response to the user request.

### FIELD OF THE DISCLOSURE

The present disclosure relates to a robot system, and more particularly, a small intelligent robot system which is suitable for a wide scope of applications. It is particularly suitable for the user to be utilized as a security system.

### BACKGROUND OF THE DISCLOSURE

Recently, robot industries are rapidly grown, and research thereon is supported all over the world. Intelligent robots for services, industries, and special purposes are being actively developed. In addition, intensive research is being carried out on functions and motions of robots to provide various high-quality services. Especially, sensing systems, communication and network technologies, various motions, and functions for overcoming obstacles and extreme topographies are added to exploring, observing, and guarding robots to perform their functions at intended positions, thereby functioning as high-performance robots that obtain reliable information and expand their fields.

However, current tracks have a number of drawbacks. For instance, the overall weight of the robot is usually too heavy and the functions thereof cannot be performed efficiently. For another instance, the current robot doesn't include an alarm system to allow the user to connect the robot to a security system or personal phone numbers, and in such a manner, the robot only provides a real-time monitoring function.

Therefore, it would be advantageous to provide a device that overcomes the aforementioned difficulties.

All referenced patents, applications, and literature are incorporated herein by reference in their entirety. Furthermore, where a definition or use of a term in a reference, which is incorporated by reference herein, is inconsistent or contrary to the definition of that term provided herein, the definition of that term provided herein applies, and the definition of that term in the reference does not apply. The disclosed embodiments may seek to satisfy one or more of the above-mentioned desires. Although the present embodiments may obviate one or more of the above-mentioned desires, it should be understood that some aspects of the embodiments might not necessarily obviate them.

### BRIEF SUMMARY OF THE DISCLOSURE

In a general implementation, a small intelligent robot system may comprise a main body including a right driving wheel and a left driving wheel on both sides thereof, and a front supporting wheel located below the main body; a camera module that takes photos located above the main body; a speech recognition module that receives input indicative of a user request; and an internet connection processor initiates a telephone call in response to the user request.

In another aspect combinable with the general implementation, the small intelligent robot system may comprise a left laser sensor and a right laser sensor at a front side of the main body.

In another aspect combinable with the general implementation, the small intelligent robot system may comprise a left ultrasonic sensor and a right ultrasonic sensor at a rear side of the main body.

In another aspect combinable with the general implementation, the small intelligent robot system may comprise a front ultrasonic sensor arranged between the right laser sensor and the left laser sensor.

In another aspect combinable with the general implementation, the small intelligent robot system may comprise a first loading platform attached to the main body, and the camera is rotatably attached on the first loading platform.

In another aspect combinable with the general implementation, the small intelligent robot system may comprise a second loading platform installed on the first loading platform, and the speech recognition module and the internet connection processor are installed on the second loading platform.

In another aspect combinable with the general implementation, the small intelligent robot system may comprise a speech synthesis module configured to generate speech synthesis data based on the input indicative of a user request.

In another aspect combinable with the general implementation, the small intelligent robot system may comprise a rear sound sensor arranged on a rear side of the main body.

In another aspect combinable with the general implementation, the small intelligent robot system may comprise a first steering gear rotatably connected with a second steering gear arranged on the main body, and the camera is arranged on the first steering gear.

In another aspect combinable with the general implementation, the small intelligent robot system may comprise a battery box on a bottom side of the main body to provide power to the system.

Among the many possible implementations of the small intelligent robot system, a first DC motor and a second DC motor may be arranged on the bottom side of the main body.

Further, it is contemplated that the small intelligent robot system includes a motor drive module arranged on the main body and connected to the first DC motor and the second DC motor to control speeds and directions of rotations of the right driving wheel and the left driving wheel.

In the alternative, the small intelligent robot system includes an Arduino control board connected to the camera and the internet connection processor to save the photos taken by the camera and instructions.

It is still further contemplated that, in the small intelligent robot system, the instructions are executed by the internet connection processor to:
activate, by a motor drive module, speeds and directions of rotations for the right driving wheel and the left driving wheel;
take, by the camera, pictures;
detect, by left and right laser sensors, distance information between the main body and obstacles;
detect, by left, right, and front ultrasonic sensors, the distance information between the main body and obstacles.

Among the many possible implementations of the small intelligent robot system, the internet connection processor is connected to the speech recognition module.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a perspective view of a small intelligent robot system according to an aspect of the embodiment.

FIG. 2 is a perspective view of the small intelligent robot system according to an aspect of the embodiment.

FIG. 3 is a bottom view of the small intelligent robot system according to an aspect of the embodiment

FIG. 4 is a block diagram of the small intelligent robot system according to the exemplary embodiment.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

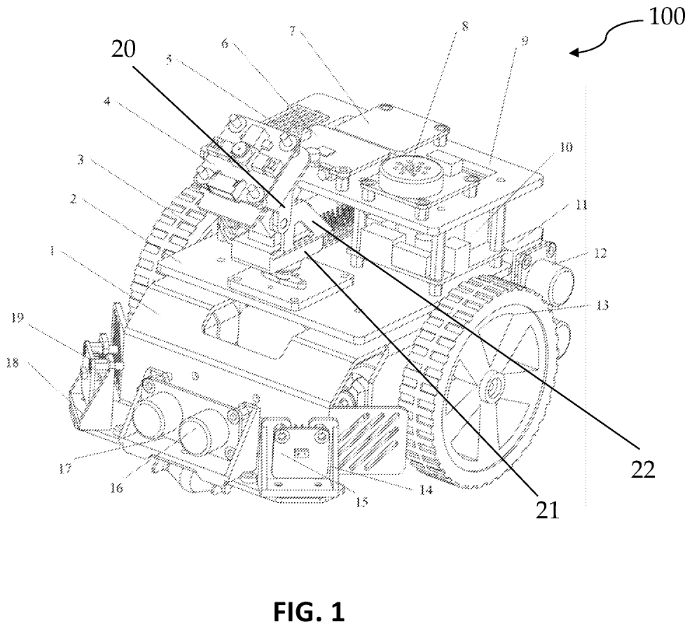

FIG. 1 generally depicts views of a small intelligent robot system 100 according to an embodiment.

Referring to FIG. 1, the small intelligent robot system 100 may comprise a main body 1 including a right driving wheel 3 and a left driving wheel 13 at both sides of the main body 1, wherein the right driving wheel 3 and the left driving wheel 13 may control directions and speeds of the small intelligent robot system 100.

As shown in further detail in FIG. 1, the small intelligent robot system 100 may further comprise a camera module 4 that takes photos arranged above the main body 1. In one embodiment, the small intelligent robot system 100 may comprise a first loading platform 2 attached on the main body 1 and the camera 4 may be rotatably attached on the first loading platform 2.

In one embodiment, the small intelligent robot system 100 may comprise a first steering gear 20 and a second steering gear 22 arranged on the first loading platform 2, wherein the first steering gear 20 may be rotatably connected with the second steering gear 22 arranged on the main body 1, and in such a manner, the first steering gear 20 may be rotated along the second steering gear 22 to perform at least two degrees of position. In still another embodiment, the camera 4 may be attached on the first steering gear 20 and may be forwardly or backwardly rotated with respect to the second steering gear 22, and in other words, the camera 4 may be rotated to perform the at least two degrees of position. In one embodiment, the small intelligent robot system 100 may further comprise a third steering gear 21 where the second steering gear 22 is affixed thereon, wherein the third steering gear 21 may be affixed on the first loading platform 2, and in such a manner, the camera 4 may be supported on the first loading platform 2 through the third steering gear 21.

In one embodiment, the small intelligent robot system 100 may comprise a speech recognition module 6 that may receive input indicative of a user request, wherein the user request may comprise voice commands which could be collected by the speech recognition module 6 to generate a set of command data. In still one embodiment, the speech recognition module 6 may be arranged on the second loading platform 2.

In one embodiment, the small intelligent robot system 100 may further comprise a speech synthesis module 8 arranged on the second loading platform 2 and communicated with the speech recognition module 6, wherein the speech synthesis module 8 may be configured to generate speech synthesis data based on the voice commands. In still one embodiment, the command data may be transmitted to the speech synthesis module 8 to generate synthesis command data.

Continuing to FIG. 1, the small intelligent robot system 100 may comprise a left laser sensor 15 and a right laser sensor 19 arranged at a front side of the main body 1. In one embodiment, the small intelligent robot system 100 may further comprise a left laser bracket 14 attached on a left-front side of the main body 1 and a right laser sensor bracket 18 attached on a right-front side of the main body 1, wherein the left laser sensor 15 may be affixed on the left laser bracket 14. In still one embodiment, the right laser sensor 19 may be affixed on the right laser sensor bracket 18.

As shown in FIG. 1, the small intelligent robot system 100 may further comprise a left ultrasonic sensor 12 arranged on a rear side of the main body 1 and a front ultrasonic sensor 16 arranged between the right laser sensor 19 and the left laser sensor 15. In one embodiment, the small intelligent robot system 100 may further comprise a front ultrasonic sensor bracket 17 affixed on the front side of the main body 1, wherein the front ultrasonic sensor 16 may be affixed on the front ultrasonic sensor bracket 17. In still one embodiment, the front ultrasonic sensor 16 may be affixed on the front side of the main body 1.

It should be noted that, in one embodiment, the left laser sensor 15 may be protected by the left laser bracket 14, and the right laser sensor 19 may be protected by the right laser sensor bracket 18. In one embodiment, the front ultrasonic sensor 16 may be protected by the front ultrasonic sensor bracket 17.

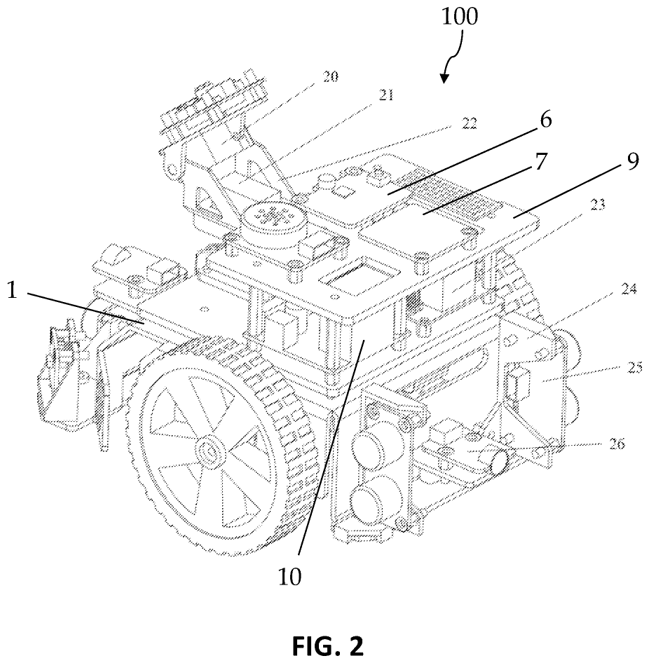

FIG. 2 generally depicts views of the small intelligent robot system 100 according to an embodiment.

Referring to FIG. 2, the small intelligent robot system 100 may further comprise an internet connection processor 7 communicating with the speech recognition module 6, and an arduino control board 23 configurated to save the photos taken by the camera 4 and instructions, wherein the internet connection processor 7 may be installed on the second loading platform 9.

In one embodiment, the small intelligent robot system 100 may further comprise a right ultrasonic sensor 25 arranged at a rear side of the main body 1. In still one embodiment, the small intelligent robot system 100 may further comprise a right ultrasonic sensor bracket 24 affixed on a right-rear side of the main body 1, wherein the right ultrasonic sensor 25 may be affixed on the right ultrasonic sensor bracket 24, and in such a way, the right ultrasonic sensor 25 may be protected by the right ultrasonic sensor bracket 24.

In one embodiment, the small intelligent robot system 100 may further comprise a rear sound sensor 26 arranged on a rear side of the main body 1. In one embodiment, the small intelligent robot system 100 may further comprise a rear sound sensor bracket arranged on the rear side of the main body 1, wherein the rear sound sensor 26 may be affixed on the rear sound sensor bracket, and in such a manner, the rear sound sensor 26 may be protected by the rear sound sensor bracket.

In one embodiment, the right laser sensor 19, the left laser sensor 15, the right ultrasonic sensor 25, the left ultrasonic sensor 12, and the front ultrasonic sensor 16 may form an obstacle avoidance system. The small intelligent robot system may identify and bypass obstacles through the above leaser and ultrasonic sensor.

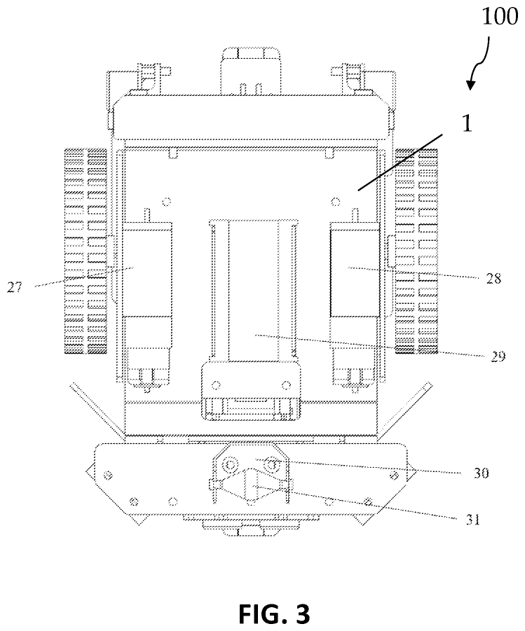

In one embodiment, the small intelligent robot system 100 may comprise a motor drive module 10 arranged on the main body 1, wherein the motor drive motor 10 may be connected to a first DC motor 27 and a second DC motor 28 (as shown in FIG. 3) to control speeds and directions of rotations of the right driving wheel 3 and the left driving wheel 13.

FIG. 3 generally depicts a bottom view of the small intelligent robot system 100 according to an embodiment.

Referring to FIG. 3, the small intelligent robot system 100 may comprise a battery box 29 located on a bottom side of the main body 1 to provide power to the system 100. In one embodiment, the small intelligent robot system 100 may further comprise the first DC motor 27 and the second DC motor 28 arranged on the bottom side of the main body 1. In still one embodiment, the small intelligent robot system 100 may further comprise a front supporting wheel 31 located below the main body 1 or on the bottom side of the main body 1.

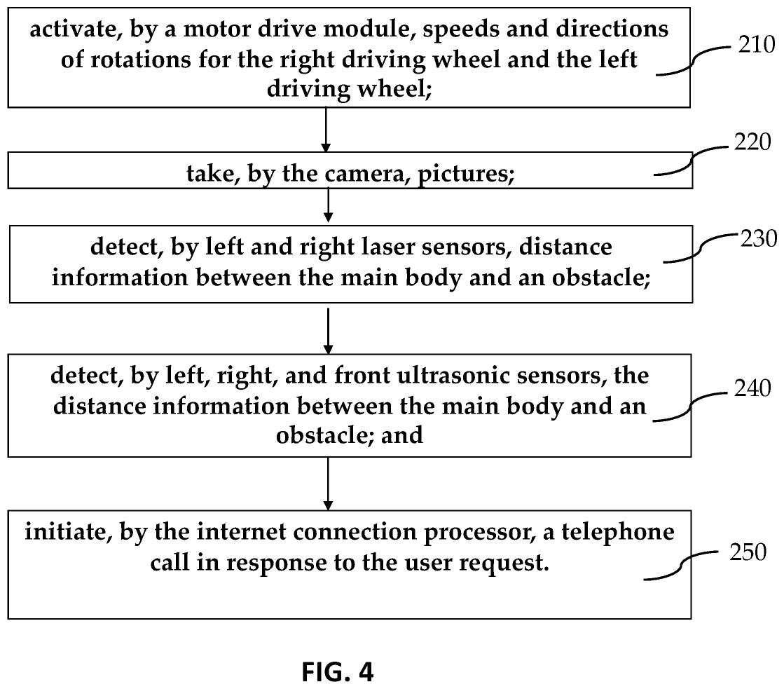

FIG. 4 generally depicts a block diagram of the small intelligent robot system 100 according to the exemplary embodiment.

Referring now to the detail of FIG. 4, the internet connection processor may be communicated with the arduino control board which saves the instructions, wherein the instructions are executed by the internet connection processor to:
activate, by a motor drive module, speeds and directions of rotations for the right driving wheel and the left driving wheel 210;
take, by the camera, pictures 220;
detect, by the left and right laser sensors, distance information between the main body and obstacles 230;
detect, by the left, right, and front ultrasonic sensors, the distance information between the main body and an obstacle 240;
initiate a telephone call by the internet connection processor in response to the user request 250.

In one embodiment, the internet connection processor may initiate the user's phone call (such as the outgoing guardian) and the user's mobile phone number can be set in advance.

In one embodiment, the small intelligent robot system 100 may be a small, light, flexible and low energy consumption intelligent robot system 100. The weight of the robot may be less than 1 kg, and the robot system 100 may be driven by four dry batteries embedded inside the battery box 29, and the right driving wheel 3 and the left driving wheel 13 may be configured to facilitate the control of the robot's motion posture.

Many alterations and modifications may be made by those having ordinary skill in the art without departing from the spirit and scope of the disclosed embodiments. Therefore, it must be understood that the illustrated embodiments have been set forth only for the purposes of example and should not be taken as limiting the embodiments defined by the following claims. For example, notwithstanding the fact that the elements of a claim are set forth below in a certain combination, it must be expressly understood that the embodiment includes other combinations of fewer, more or different elements, which are disclosed herein even when not initially claimed in such combinations.

Thus, specific embodiments and applications of the small intelligent robot system have been disclosed. It should be apparent, however, to those skilled in the art that many more modifications besides those already described are possible without departing from the disclosed concepts herein. The disclosed embodiments, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the embodiments. In addition, where the specification and claims refer to at least one of something selected from the group consisting of A, B, C and N, the text should be interpreted as requiring at least one element from the group which includes N, not A plus N, or B plus N, etc.

The words used in this specification to describe the various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

What is claimed is:

1. Small intelligent robot system, comprising:
a main body comprising a right driving wheel and a left driving wheel at both sides thereof;
a camera module that takes photos located above the main body;
a speech recognition module that receives input indicative of a user request; and
an internet connection processor that initiates a telephone call in response to the user request.

2. The small intelligent robot system of claim 1, further comprising a left laser sensor and a right laser sensor at a front side of the main body.

3. The small intelligent robot system of claim 1, further comprising a left ultrasonic sensor and a right ultrasonic sensor at a rear side of the main body.

4. The small intelligent robot system of claim 2, further comprising a front ultrasonic sensor arranged between the right and left laser sensor.

5. The small intelligent robot system of claim 1, further comprising a first loading platform attached on the main body and the camera is rotatably attached on the first loading platform.

6. The small intelligent robot system of claim 1, further comprising a second loading platform installed on a first loading platform, and the speech recognition module and the internet connection processor are installed on the second loading platform.

7. The small intelligent robot system of claim 1, further comprising a speech synthesis module configured to generate speech synthesis data based on the input indicative of the user request.

8. The small intelligent robot system of claim 1, further comprising a rear sound sensor arranged on a rear side of the main body.

9. The small intelligent robot system of claim 1, further comprising a first steering gear rotatably connected with a second steering gear arranged on the main body and the camera is arranged on the first steering gear.

10. The small intelligent robot system of claim 1, further comprising a battery box located on a bottom side of the main body to provide power to the system.

11. The small intelligent robot system of claim 1, further comprising a first DC motor and a second DC motor arranged on a bottom side of the main body.

12. The small intelligent robot system of claim 11, further comprising a motor drive module arranged on the main body and connected to the first DC motor and the second DC motor to control speeds and directions of rotations of the right driving wheel and the left driving wheel.

13. The small intelligent robot system of claim 1, further comprising an arduino control board connected to the camera and the internet connection processor to save the photos taken by the camera and instructions.

14. The small intelligent robot system of claim 13, wherein the instructions are executed by the internet connection processor to:
activate, by a motor drive module, speeds and directions of rotations for the right driving wheel and the left driving wheel;
take, by the camera, pictures;
detect, by the left and right laser sensors, distance information between the main body and obstacles; and
detect, by left, right, and front ultrasonic sensors, the distance information between the main body and obstacles.

15. The small intelligent robot system of claim 1, wherein the internet connection processor is connected to the speech recognition module.
